(19) United States
(12) Patent Application Publication
(10) Pub. No.: US 2006/0261620 A1
(43) Pub. Date: Nov. 23, 2006

(54) Anti-shock mechanisms

(75) Inventors: Lung-Chi Lu, Taipei County (TW); Kuo-Hua Chang, Taipei County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/417,785

(22) Filed: May 3, 2006

(30) Foreign Application Priority Data
May 9, 2005 (TW) TW94114887

(51) Int. Cl. B60J 9/00

(52) U.S. Cl. 296/1.07

(57) ABSTRACT

Anti-shock mechanisms for electronic devices are provided. An anti-shock mechanism includes a plurality of first rods and first buffers. The first rods perpendicularly project from a first side of the electronic device, wherein the first side is substantially parallel to a moving direction of the vehicle. Each of the first buffers comprises a first opening, and the first rods are inserted in the first openings respectively.

### BACKGROUND

The invention relates in general to anti-shock mechanisms and in particular to anti-shock mechanisms for electronic devices applied in vehicles.

With wide applications of CD-ROMs and hard disk devices in vehicles, anti-shock mechanisms have become critical, with heat dissipation thereof important.

Typical vibration in a moving vehicle is between 0-4 G and 5 Hz-100 Hz. Generally, foam materials are provided as a conventional anti-shock measure, enclosing the electronic device. However, foam materials provide poor heat dissipation and cannot be used for a long time. Further, the volume thereof is inevitably higher due to the foam material surrounding the electronic device.

### SUMMARY

Anti-shock mechanisms for electronic devices are provided. An anti-shock mechanism includes a plurality of first rods and first buffers. The first rods perpendicularly project from a first side of the electronic device, wherein the first side is substantially parallel to a moving direction of the vehicle. Each of the first buffers comprises a first opening. The first rods are respectively inserted in the first openings.

### DESCRIPTION OF THE DRAWINGS

FIG. 1 is an exploded diagram of an embodiment of an anti-shock mechanism for an electronic device;

FIG. 2 is a perspective diagram of the anti-shock mechanism shown in FIG. 1; and

FIG. 3 is a perspective diagram of another embodiment of an anti-shock mechanism for an electronic device.

### DETAILED DESCRIPTION

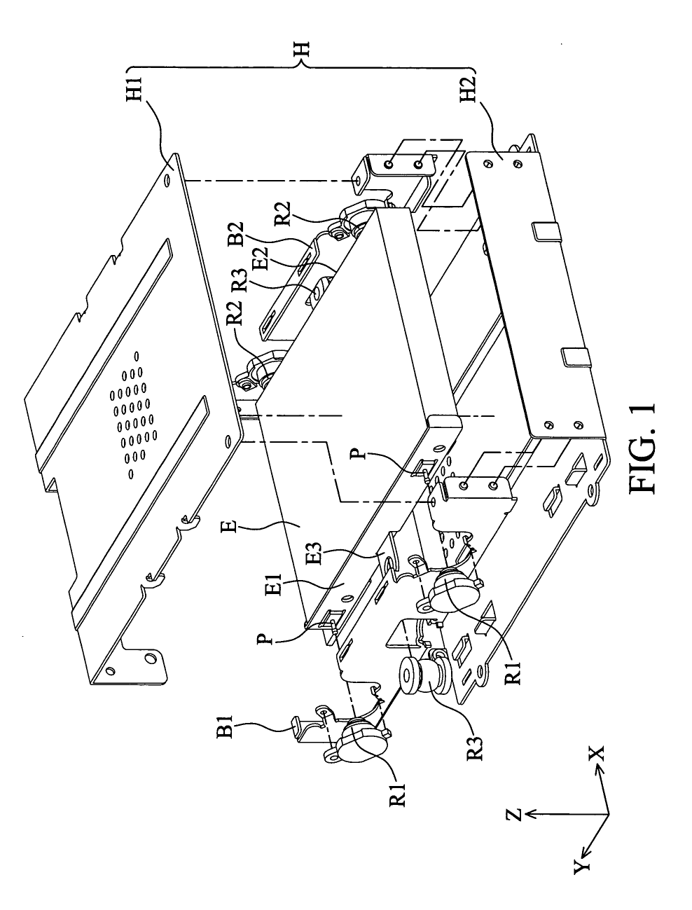

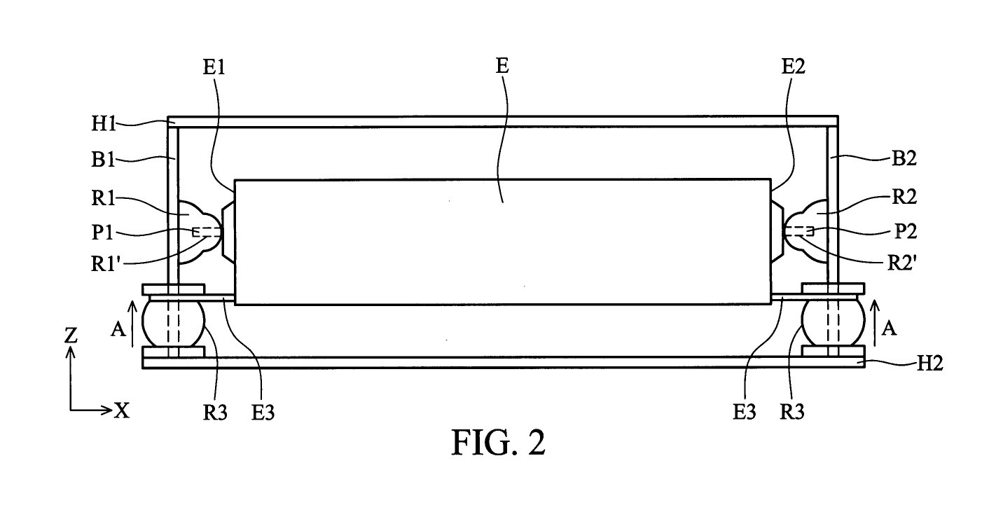

Referring to FIGS. 1 and 2, an exemplary embodiment of an anti-shock mechanism is provided for an electronic device E in a vehicle. The anti-shock mechanism primarily comprises a housing H, a first bracket B1, a second bracket B2, a plurality of first and second rods P1 and P2, and a plurality of first, second, and third buffers R1, R2, and R3. The electronic device E, such as a CD-ROM or hard disk device, is enclosed by the housing H fixed to the vehicle.

As shown in FIG. 2, the first rods P1 project from a first side E1 of the electronic device E, and the second rods P2 project from a second side E2 of the electronic device E, respectively. The first side E1 is opposite the second side E2 and substantially parallel to a moving direction of the vehicle (Y direction). Specifically, the first and second rods P1 and P2 are substantially perpendicular to the first and second sides E1 and E2.

The first and second brackets B1 and B2 are disposed on the first and second sides E1 and E2 respectively, both connecting to the upper housing H1 and the lower housing H2. As shown in FIGS. 1 and 2, two first buffers R1 are mounted on the first bracket B1, and two second buffers R2 are mounted on the second bracket B2. With regard to FIG. 2, each first buffer R1 has an opening R1′ with the first rod P1 inserted therein, and correspondingly, each second buffer R2 has an opening R2′ with the second rod P2 inserted therein. As the buffers R1 and R2 surround the rods P1 and P2 respectively, the electronic device E is sustained, and shocks in Y and Z directions (perpendicular to the rods P1 and P2) are absorbed.

Since primary shock from the vehicle are substantially along Y and Z directions, the buffers R1 and R2 can provide sufficient absorption and better heat dissipation than traditional foam materials. Further, as the first and second buffers R1 and R2 are connected by the first and second brackets B1 and B2, respectively, shock is averagely absorbed.

In FIGS. 1 and 2, each third buffer R3 abuts between the lower housing H2 and a protruding contact portion E3 of the electronic device E, substantially in a first direction A (Z direction). The first direction A is perpendicular to the moving direction of the vehicle (Y direction), and the rods R1 and R2 (X direction). The third buffers R3 can absorb shock substantially along Z axis, providing better heat dissipation than foam materials. In some embodiments, the buffers R1, R2 and R3 may comprise rubber or other flexible materials.

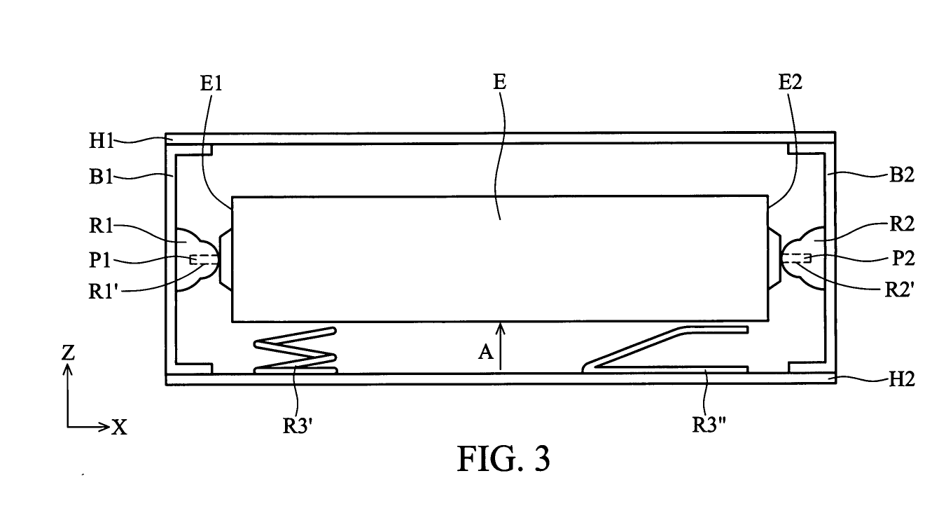

Referring to FIG. 3, in some embodiments, the third buffer R3 can be substituted by a spring R3′ or a flexible sheet R3″ separated from the electronic device E. As shown in FIG. 3, the electronic device E is suspended merely by the buffers R1 and R2 and rods P1 and P2. When the electronic device E suffers shock along Z direction, the spring R3′ and the flexible sheet R3″ touch the electronic device E, providing a resilient force to absorb shock.

Anti-shock mechanisms for electronic devices in vehicles are provided according to the embodiments. The electronic device is sustained and shock is sufficiently absorbed by the buffers R1 and R2 with the rods P1 and P2 inserted therein, saving space and providing better heat dissipation than foam materials.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An anti-shock mechanism for an electronic device in a vehicle, comprising:
a plurality of first rods, perpendicularly projecting from a first side of the electronic device, wherein the first side is substantially parallel to a moving direction of the vehicle; and
a plurality of first buffers, wherein each of the first buffers comprises a first opening, and the first rods are respectively inserted in the first openings.

2. The anti-shock mechanism as claimed in claim 1, further comprising a first bracket disposed on the first side of the electronic device and connected to the first buffers.

3. The anti-shock mechanism as claimed in claim 1, further comprising a plurality of second buffers and a plurality of second rods disposed on a second side of the electronic device, wherein the second side is opposite the first side, and each of the second buffers comprises a second opening with the second rod inserted therein.

4. The anti-shock mechanism as claimed in claim 3, further comprising a first bracket disposed on the first side and a second bracket disposed on the second side, wherein the first bracket connects the first rods, and the second bracket connects the second rods.

5. The anti-shock mechanism as claimed in claim 3, further comprising a housing and a third buffer, wherein the third buffer abuts the housing in a first direction, substantially perpendicular to the first, second rods and the moving direction of the vehicle.

6. The anti-shock mechanism as claimed in claim 3, further comprising a housing and a third buffer connected to the housing, wherein the third buffer is separated from the electronic device.

7. The anti-shock mechanism as claimed in claim 4, further comprising a third buffer connected to the housing, wherein the first, second brackets and the housing are fixed.

8. The anti-shock mechanism as claimed in claim 5, wherein the third buffer comprises a spring.

9. The anti-shock mechanism as claimed in claim 5, wherein the third buffer comprises a flexible sheet.

10. An anti-shock mechanism for an electronic device in a vehicle, comprising:
a plurality of first rods, disposed on a first side of the electronic device, wherein the first side is substantially parallel to a moving direction of the vehicle and substantially perpendicular to the first rods; and
a plurality of first buffers, surrounding the first rods respectively, to absorb vibration substantially perpendicular to the first rods.

11. The anti-shock mechanism as claimed in claim 10, further comprising a first bracket disposed on the first side of the electronic device and connected to the first buffers.

12. The anti-shock mechanism as claimed in claim 10, further comprising a plurality of second buffers and a plurality of second rods disposed on a second side of the electronic device, wherein the second side is opposite the first side, and the second buffers surround the second rods respectively.

13. The anti-shock mechanism as claimed in claim 12, further comprising a first bracket disposed on the first side and a second bracket disposed on the second side, wherein the first bracket connects the first rods, and the second bracket connects the second rods.

14. The anti-shock mechanism as claimed in claim 12, further comprising a housing and a third buffer, wherein the third buffer abuts the housing in a first direction, substantially perpendicular to the first, second rods and the moving direction of the vehicle.

15. The anti-shock mechanism as claimed in claim 12, further comprising a housing and a third buffer connected to the housing, wherein the third buffer is separated from the electronic device.

16. The anti-shock mechanism as claimed in claim 13, further comprising a third buffer connected to the housing, wherein the first, second brackets and the housing are fixed.

17. The anti-shock mechanism as claimed in claim 14, wherein the third buffer comprises a spring.

18. The anti-shock mechanism as claimed in claim 14, wherein the third buffer comprises a flexible sheet.
